(19) United States
(12) Patent Application Publication
(10) Pub. No.: US 2025/0300561 A1
(43) Pub. Date: Sep. 25, 2025

(54) DYNAMICALLY CONFIGURABLE POWER CONVERSION TOPOLOGY

(71) Applicant: QUALCOMM Incorporated, San Diego, CA (US)

(72) Inventors: David Eric HAGLAN, Tempe, AZ (US); Gordon LEE, Gilbert, AZ (US)

(21) Appl. No.: 18/610,784

(22) Filed: Mar. 20, 2024

(51) Int. Cl. H02M 3/158; H02M 1/32

(52) U.S. Cl. CPC H02M 3/1584; H02M 1/32

(57) ABSTRACT

Certain aspects of the present disclosure are directed towards a power supply circuit. The power supply circuit generally includes: a switched-mode power supply (SMPS); a detector circuit coupled to the SMPS and configured to detect a presence of one or more circuit elements of the SMPS; and a controller coupled to the detector circuit and configured to configure the SMPS to operate with a number of converter phases based on a number of the one or more circuit elements that are present.

### TECHNICAL FIELD

Certain aspects of the present disclosure generally relate to electronic circuits and, more particularly, to a dynamically configurable power supply circuit.

### BACKGROUND

A voltage regulator may provide a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS that may include: (1) a high-side switch coupled between a relatively higher voltage rail and a switching node, (2) a low-side switch coupled between the switching node and a relatively lower voltage rail, (3) and an inductor coupled between the switching node and a load. The high-side and low-side switches are typically implemented with transistors, although the low-side switch may alternatively be implemented with a diode.

Power management integrated circuits (power management ICs or PMICs) are used for managing the power scheme of a host system and may include and/or control one or more voltage regulators (e.g., buck converters and/or LDOs). A PMIC may be used in battery-operated devices, such as mobile phones, tablets, laptops, wearables, etc., to control the flow and direction of electrical power in the devices. The PMIC may perform a variety of functions for the device, such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a power supply circuit. The power supply circuit generally includes: a switched-mode power supply (SMPS); a detector circuit coupled to the SMPS and configured to detect a presence of one or more circuit elements of the SMPS; and a controller coupled to the detector circuit and configured to configure the SMPS to operate with a number of converter phases based on a number of the one or more circuit elements that are present.

Certain aspects of the present disclosure are directed towards a method for voltage regulation. The method generally includes: detecting a presence of one or more circuit elements of a SMPS; configuring the SMPS to operate with a number of converter phases based on a number of the one or more circuit elements that are present; and generating, via the SMPS, a regulated voltage using the number of converter phases.

Certain aspects of the present disclosure are directed towards an apparatus for voltage regulation. The apparatus generally includes a memory and one or more processors coupled to the memory, the one or more processors being configured to: receive an indication of a presence of one or more circuit elements of a SMPS; and configure the SMPS to operate with a number of converter phases based on a number of the one or more circuit elements that are present, wherein a regulated voltage is generated via the SMPS using the number of converter phases.

Certain aspects of the present disclosure are directed towards a power supply circuit. The power supply circuit generally includes: a SMPS comprising: a HS switch coupled between a voltage rail and a VSW node, the VSW node being coupled to a respective one of a plurality of inductive elements of the SMPS; and a LS switch coupled between the VSW node and a reference potential node; and a first resistive element selectively coupled between the voltage rail and the VSW node of the SMPS; and a comparator having an input coupled to the VSW node.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device that includes a power supply system with at least one switched-mode power supply (SMPS) circuit, in which aspects of the present disclosure may be practiced.

FIG. 2 illustrates an electronic device having a system-on-chip (SOC) core and a multi-phase buck converter, in accordance with certain aspects of the present disclosure.

FIGS. 3A and 3B illustrate a buck converter phase with detection circuitry for detecting an inductive element, in accordance with certain aspects of the present disclosure.

FIG. 4 is a flow diagram illustrating example operations for dynamic configuration of an electronic device, in accordance with certain aspects of the present disclosure.

FIG. 5 is a flow diagram illustrating example operations for voltage regulation, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards operating a power supply circuit. In some aspects, the presence of one or more circuit elements (e.g., inductive elements) used by the power supply circuit may be detected, allowing configuration of the power supply circuit and one or more processing units drawing power from the power supply circuit. The power supply circuit may be a switched-mode power supply (SMPS), such as a multi-phase buck converter, although the aspects of the present disclosure may be implemented for any suitable power supply topology.

It may be difficult to detect a missing inductive element of an SMPS (e.g., multi-phase converter) for a typical electronic device. If an inductive element of the multi-phase converter disconnects from the converter, the converter may continue to operate at lower efficiency, which may lead to an overcurrent condition causing the supply voltage to collapse resulting in a system crash. This condition may be difficult to diagnose. Some aspects of the present disclosure are directed towards detecting one or more inductive elements, operating an SMPS with a number of phases based on the detection, and communicating the detected inductive elements to an SOC. The SOC may adjust operating conditions so that the SOC does not draw more power than the SMPS can provide. For example, suppose a two-phase buck converter has only one output inductive element. In that case, the converter may be operated with a single phase, and the SOC may be notified to operate at reduced power. In this manner, the electronic device would still continue to function, and the defect may be communicated to prevent the SOC from using more power than the single phase can provide. In addition to the detection of the inductive element for phase configuration, inductive element detection may be used to detect manufacturing defects. For instance, during factory test, a controller may report the detected inductive elements, allowing for defect detection during manufacturing.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatuses, such as in the power supply, battery charging circuit, or power management circuit of a communication system, a video codec, audio equipment such as music players and microphones, a television, camera equipment, and test equipment such as an oscilloscope.

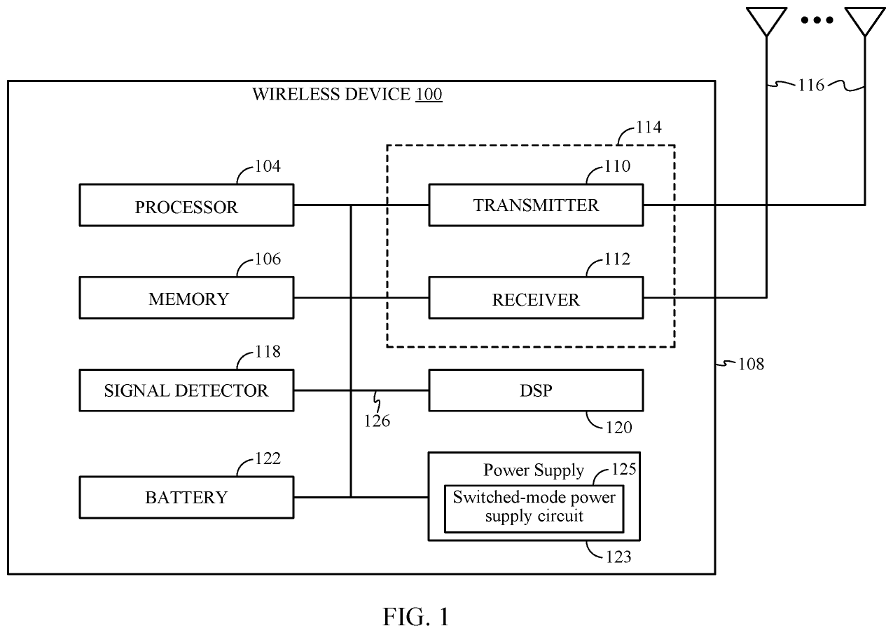

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, a virtual reality (VR) or augmented reality (AR) device, etc.

The device 100 may include a processor 104 that controls operation of the device 100. The processor 104 may also be referred to as a central processing unit (CPU). Memory 106 provides instructions and data to the processor 104. The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when the device is disconnected from an external power source). The device 100 may also include a power supply system 123 for managing the power from the battery (or from one or more power ports for receiving external power) to the various components of the device 100. At least a portion of the power supply system 123 may be implemented in one or more power management integrated circuits (power management ICs or PMICs) The power supply system 123 may perform a variety of functions for the device 100 such as DC-to-DC conversion, battery charging, power-source selection, voltage scaling, power sequencing, etc. For example, the power supply system 123 may include one or more power supply circuits, which may include a switched-mode power supply circuit 125. The switched-mode power supply circuit 125 may be implemented by any of various suitable switched-mode power supply circuit topologies, such as a three-level buck converter, a divide-by-two (Div2) charge pump, or an adaptive combination power supply circuit, which can switch between operating in a three-level buck converter mode and a two-level buck converter mode. In some aspects, the switched-mode power supply circuit 125 may be dynamically configurable, as described in more detail herein.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Scheme

Certain aspects of the present disclosure are directed towards detection of inductive elements (e.g., which may be on a circuit board implemented in hardware, or integrated within a chip such as a PMIC). Some aspects provide an adaptive regulator configuration (e.g., an adaptive buck configuration) based on detected inductive elements. In some implementations, the adaptive regulator configuration techniques described herein may be implemented as part of programmable boot sequence (PBS) software. The PBS software may run on a power management integrated circuit (PMIC), in some cases. The reporting of detected inductive elements may be used to modify the behavior of a system-on-chip (SOC), as described in more detail herein.

Customers using a PMIC may have different product line versions to cover different price points. Moreover, a line of SOCs may be provided with different capabilities. For example, a graphics core might have eight slices (e.g., cores), but due to manufacturing defects, a die might have only six or seven slices free of defects. If slices are defective, the die can be sold as part of a lower-cost product version with one or more slices disabled. Some SOCs may be tested and binned to operate at a higher frequency (or other operating characteristics) than other SOCs, and thus, may be sold for a premium. The different tiers of products have different power specifications. A product manufacturer may use the same circuit board design across all the product versions. For high-tier products with all slices operating at a higher frequency, the SOC may use a maximum number of phases for a switched-mode power supply (SMPS) to supply more power to the SOC. As the performance is reduced and slices are disabled, the number of phases that are used may be reduced. For a low-tier product that uses less power, fewer inductive and capacitive elements may be populated for the power supply.

In some applications (e.g., automotive applications), defect detection techniques may be used to increase product reliability. Certain aspects of the present disclosure are directed toward techniques for detecting a missing or open (e.g., disconnected) inductive element before an SMPS is enabled. Based on the detection, the SMPS may be configured with a number of phases, and an SOC may become aware of issues, allowing the SOC to take one or more actions. For example, the SOC may adjust operation based on the knowledge of missing inductive elements and/or communicate the issue (e.g., missing inductive element). For instance, an automotive product may turn on a “service required” dash light and/or communicate the issue to a manufacturer's service center.

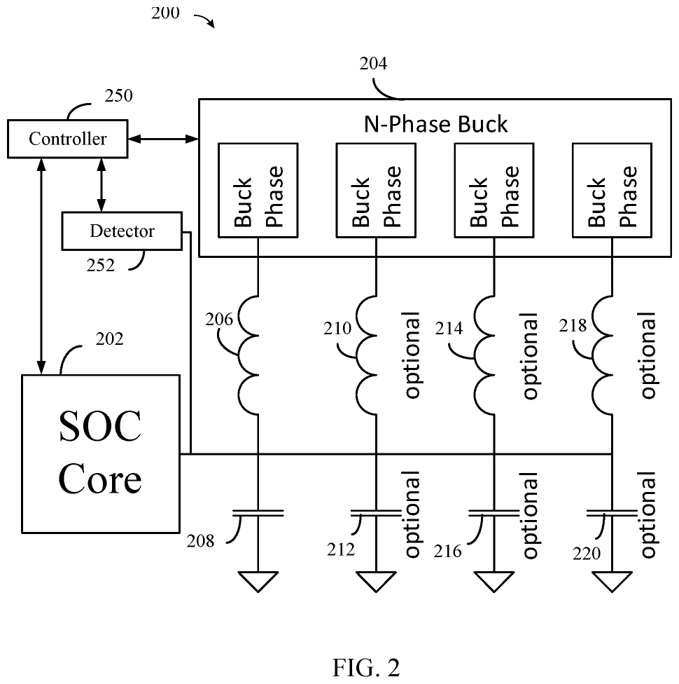

FIG. 2 illustrates an electronic device 200 having an SOC core 202 and an N-phase buck converter 204, N being any positive integer, in accordance with certain aspects of the present disclosure. While an N-phase buck converter (also referred to herein as a multi-phase buck converter) is shown to facilitate understanding, certain aspects of the present disclosure may be applied for any suitable SMPS configuration (e.g., boost converter or buck-boost converter). The multi-phase buck converter 204 may power a high-performance core 202 of an SOC (e.g., such as a central processing unit (CPU), graphical processing unit (GPU), or neural processing unit (NPU)). As shown, the converter 204 may be capable of operating with up to four phases. Each of the four buck phases may include switches for voltage regulation using a respective one of the inductive elements 206, 210, 214, 218. The inductive elements 206, 210, 214, 218 may be external to an integrated circuit (e.g., PMIC), or integrated as part of an integrated circuit in some applications.

In some implementations (e.g., for a high-tier product), all four inductive elements (e.g., and associated capacitive elements 208, 212, 216, 220) may be included in order to use all four phases of the buck converter 204. However, for a lower-tier product, fewer than four inductive elements (e.g., only one inductive element) and associated capacitive element(s) may be included, such as inductive element 206 and capacitive element 208. The multi-phase buck converter 204 may be adjusted to account for the number of inductive and capacitive elements coupled to the converter 204. For instance, if only inductive elements 206, 210 and capacitive elements 208, 212 are coupled to the converter 204, then the converter 204 may be configured to operate as a two-phase converter.

Certain aspects of the present disclosure are directed towards techniques for detecting the presence or connectivity of one or more inductive elements, allowing one or more actions to be taken for an SOC (or any processing unit) and SMPS. For example, the electronic device 200 may include a detector 252 that is configured to detect the presence of the inductive elements 206, 210, 214, 218. Based on the detection, a controller may configure the SOC core 202 and/or the buck converter 204, as described in more detail herein. In some aspects, the controller 250 may be part of the SOC, part of the PMIC, or external to the SOC and PMIC. While some examples provided herein are described with respect to detecting the presence of inductive elements to facilitate understanding, certain aspects of the present disclosure may be used to detect any circuit elements (e.g., such as the presence of capacitive elements 208, 212, 216, 220).

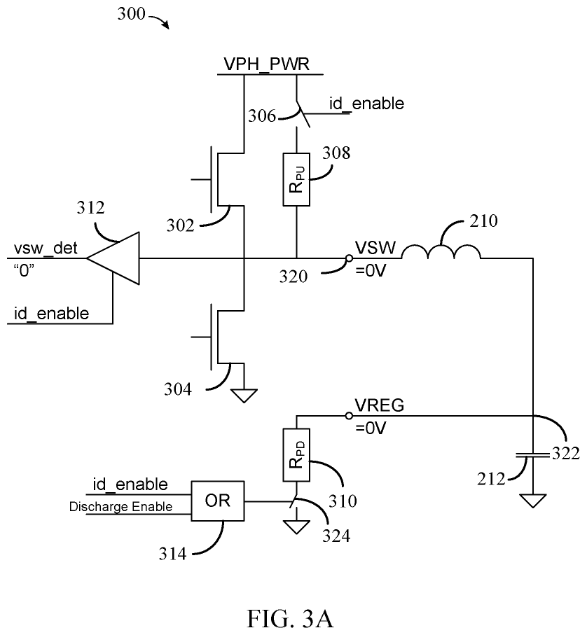

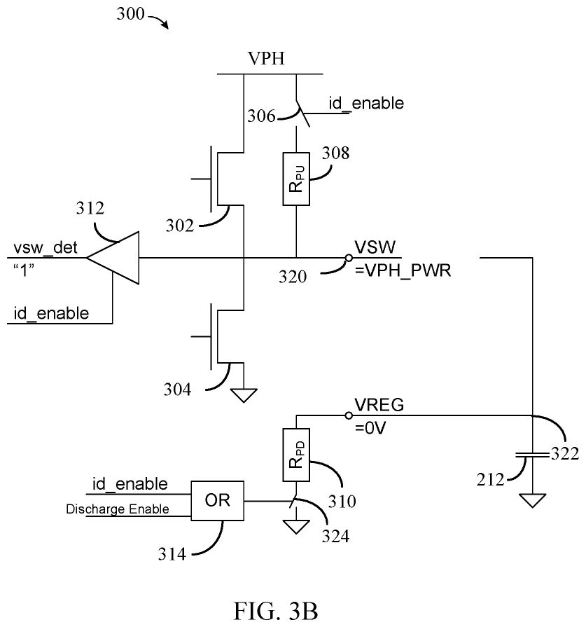

FIGS. 3A and 3B illustrate a power supply circuit 300 having a buck converter phase with detection circuitry for detecting an inductive element, in accordance with certain aspects of the present disclosure. FIG. 3A illustrates the power supply circuit 300 with an inductive element 210 being present, and FIG. 3B illustrates the power supply circuit 300 with the inductive element 210 not being present (e.g., or disconnected).

During SMPS initialization (e.g., such as during system boot-up), a detector (e.g., detector 252) may be used to check for the presence of one or more inductive elements, allowing for the enabling or disabling of one or more phases of the SMPS. To detect the presence of the one or more inductive elements, a controller (e.g., controller 250) may control one or more switches of the detector, as described in more detail herein.

As shown, the buck converter phase may include a high-side (HS) switch 302 and a low-side (LS) switch 304. The HS and LS switches 302, 304 may be controlled to charge and discharge an inductive element 210 to generate a regulated voltage (VREG) based on a supply voltage (VPH) at a voltage rail. As shown, a pull-up (PU) resistive element 308 (labeled “R_{PU}”) may be selectively coupled between the voltage rail and a switching voltage (VSW) node 320. The VSW node 320 may be between the HS and LS switches 302, 304, as shown. The inductive element 210 may be coupled between the VSW node 320 and an output node 322 at which VREG is generated. The capacitive element 212 is coupled between the output node 322 and a reference potential node (e.g., electric ground), as shown. A pull-down (PD) resistive element 310 (labeled “R_{PD}”) may be selectively coupled between the output node 322 and the reference potential node using a series switch 324.

The detection of the inductive element 210 may be performed by closing switch 324 to couple the resistive element 310 (e.g., a relatively lower resistance element, such as a 50Ω resistive element) between the output node 322 and the reference potential node, setting VREG at the output node 322 to zero volts. The switch 306 may be closed, coupling the resistive element 308 (e.g., a relatively higher resistance element, such as a 5 kΩ resistive element) between the voltage rail and the VSW node 320. Switches 306, 324 may be closed by transitioning an inductor detect enable (id_enable) signal from logic low to logic high. As shown, the id_enable signal may be provided to a first input of an OR gate 314, where a second input of the OR gate 314 receives a discharge enable signal. The discharge enable signal may be used to discharge the capacitive element 212 during operation of the buck converter. The output of the OR gate 314 may be coupled to a control input of switch 324, as shown.

If the inductive element 210 is present as shown in FIG. 3A, VSW at the VSW node 320 may be equal to 0 volts (or at least less than a threshold voltage) since the resistance of the resistive element 310 is less than the resistance of the resistive element 308. If the inductive element is removed (or disconnected), as shown in FIG. 3B, the voltage at the VSW node 320 may be pulled up to VPH (e.g., since the VSW node 320 is not coupled to the output node 322).

A comparator 312 may compare the voltage at the VSW node with a voltage threshold and generate a detect signal (vsw_det). For example, if VSW is less than the threshold voltage indicating that the inductive element is present, then the detect signal may be logic zero. If VSW is greater than the threshold voltage indicating that the inductive element is not present (or disconnected), then the detect signal may be logic high. The controller (e.g., controller 250) may read the detect signal and configure the converter or SOC, as described herein. For example, the controller may determine whether to enable or disable a phase of the buck converter based on whether the inductive element is present. As shown, the comparator 312 may be enabled via the id_enable signal during inductive element detection, and disabled otherwise.

The switches 306, 324, resistive elements 308, 310 and comparator 312 may be part of the detector 252 described with respect to FIG. 2. The detector may include detection circuitry (e.g., including at least the switch 306, resistive element 308, and comparator 312) for each of the inductive elements of the SMPS. Thus, a separate detect signal may be provided for each inductive element. In some cases, the detection circuitry may operate in parallel to detect the presence of respective inductive elements, or operate consecutively. Switches 306, 324 may be opened during the operation of the buck converter (e.g., during voltage regulation).

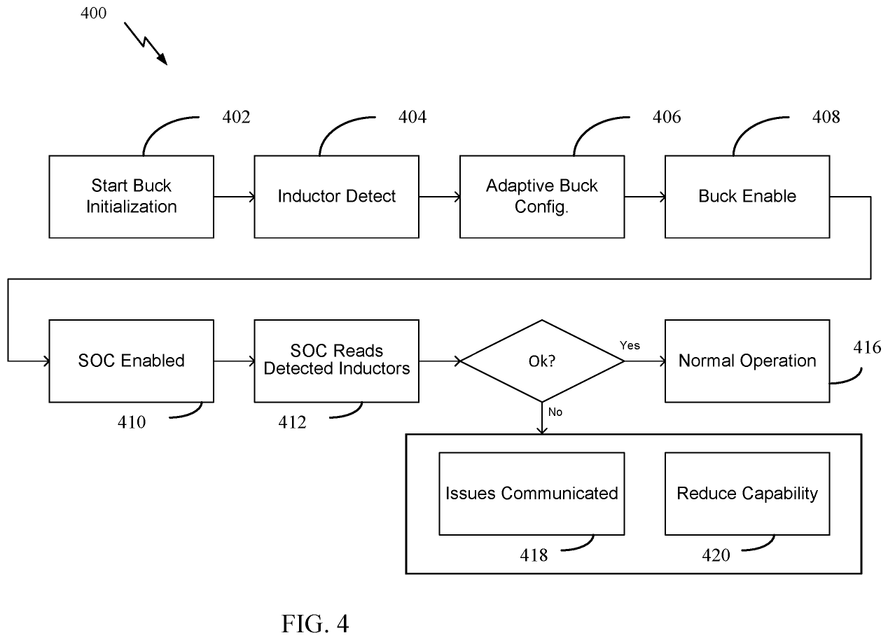

FIG. 4 is a flow diagram illustrating example operations 400 for dynamic configuration of an electronic device, in accordance with certain aspects of the present disclosure. At block 402, power supply initialization (e.g., power up) may begin. At block 404, the inductive element detection process described herein may be performed to detect whether one or more inductive elements are not present. The results of the detection may be stored in memory (e.g., memory 106 of FIG. 1 or a memory as part of the PMIC), in some aspects. At block 406, based on the detection, an adaptive buck configuration may be performed to configure one or more phases of the buck converter as described. At block 408, the buck converter is enabled, and at block 410, the SOC is enabled (e.g., released from reset). At block 412, the SOC as part of a boot process, may read from memory which inductive elements are detected. In some aspects, the SOC may compare the number of inductive elements detected to an expected number of inductive elements to be present. Based on the comparison, the SOC may, at block 416, continue normal operations or perform one or more actions such as operate with reduced capabilities at block 420 to reduce power consumption and/or communicate an error at block 418. The detection scheme described herein may be used for a manufacturing integrity check and/or field validation of expected component presence or state of health (e.g., as failed inductive elements tend to result in an open circuit mimicking a missing inductor condition detectable by the techniques described herein). For example, the communication of a detected error at block 418 may facilitate a manufacturing integrity check or field validation.

While aspects related to using PBS is described, the detection operations may be performed during an integrity check locally with a digital machine that initiates a self-check routine. The self-check results may be stored for subsequent system consideration on whether there is a satisfactory state of health to support normal booting, a reduced capability boot flow, or block booting altogether, depending on what domains are compromised.

The detection scheme described herein may be performed without disturbing the output voltage of the buck regulator during the inductor presence interrogation. For example, VREG may stay close to OV whether or not the inductive element is present. This is important as it allows for the device to be scanned for inductive element presence without having to account for voltage dependencies or sensitivities of other circuits, which is particularly beneficial given the complex power grids in modern chipsets where voltage sequence ordering is important to reduce device stress. With VREG being undisturbed, the interrogation of multiple components may be launched and performed in parallel for efficiency and expediency. The interrogation may be initiated via a broadcasted command, during power-up, or upon enabling the SMPS.

While some examples provided herein are directed towards an inductor detection scheme to address the difficulty in detecting missing inductive elements in a multi-phase buck configuration, the aspects of the present disclosure may applied in single-phase domains. The detection scheme may facilitate an integrity check of SMPSs in a device during the pre-boot interrogation, as the SMPSs may be launched in parallel. In this manner, errors with one or more SMPSs may be identified early (e.g., don't have to wait till a non-default-on single-phase SMPS is enabled to find out there is an issue with an important component).

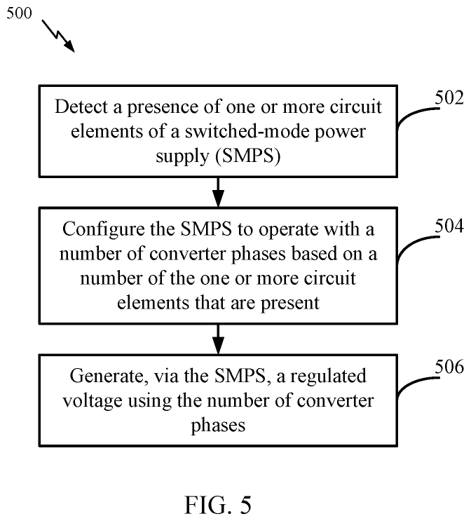

FIG. 5 is a flow diagram illustrating example operations 500 for voltage regulation, in accordance with certain aspects of the present disclosure. The operations 500 may be performed, for example, by an electronic device, such as the electronic device 200.

At block 502, the electronic device detects a presence of one or more circuit elements of a switched-mode power supply (SMPS) (e.g., converter 204). At block 504, the electronic device configures the SMPS to operate with a number of converter phases (e.g., which may include a single phase for a single phase SMPS) based on a number of the one or more circuit elements that are present. At block 506, the electronic device generates, via the SMPS, a regulated voltage (e.g., VREG) using the number of converter phases. In some aspects, detection of a presence of one or more circuitry elements may be performed for one or more other SMPSs in parallel with the detection at block 502. The detection may be initiated based on reception of a broadcasted command, during the power-up of the electronic device, or upon enabling the SMPS.

In some aspects, the one or more circuit elements of the SMPS may include one or more of a plurality of inductive elements (e.g., inductive elements 206, 210, 214, 218) associated with multiple converter phases of the SMPS. In some aspects, generating the regulated voltage may include, for each of the multiple converter phases, charging a respective one of the plurality of inductive elements via a HS switch (e.g., HS switch 302) coupled between a voltage rail and a VSW node (e.g., VSW node 320), the VSW node being coupled to the respective one of the plurality of inductive elements, and discharging the respective one of the plurality of inductive elements via a LS switch (e.g., LS switch 304) coupled between the VSW node and a reference potential node.

In some aspects, detecting the presence of the one or more circuit elements may include: coupling a first resistive element (e.g., resistive element 308) between a voltage rail and a VSW node of the SMPS; and comparing (e.g., via comparator 312) a voltage at the VSW node to a threshold to detect the presence of the one or more circuit elements. Detecting the presence of the one or more circuit elements may also include coupling a second resistive element (e.g., resistive element 310) between an output node (e.g., output node 322) of the SMPS and a reference potential node. In some aspects, coupling the first resistive element between the voltage rail and the VSW node of the SMPS to detect the presence of the one or more circuit elements may include closing a switch (e.g., switch 306) coupled in series with the first resistive element. The electronic device may open the switch to generate the regulated voltage.

In some aspects, the electronic device may cause one or more processing units (e.g., SOC core 202) to reduce power consumption based on the number of the one or more circuit elements that are present. The electronic device may output a notification of the number of the one or more circuit elements that are present.

### Example Aspects

Aspect 1: A power supply circuit, comprising: a switched-mode power supply (SMPS); a detector circuit coupled to the SMPS and configured to detect a presence of one or more circuit elements of the SMPS; and a controller coupled to the detector circuit and configured to control the SMPS to operate with a number of converter phases based on a number of the one or more circuit elements that are present.
Aspect 2: The power supply circuit of Aspect 1, wherein the one or more circuit elements of the SMPS comprise one or more of a plurality of inductive elements associated with multiple converter phases of the SMPS.
Aspect 3: The power supply circuit of Aspect 2, wherein the SMPS comprises, for each of the multiple converter phases: a high-side (HS) switch coupled between a voltage rail and a switching voltage (VSW) node, the VSW node being coupled to a respective one of the plurality of inductive elements; and a low-side (LS) switch coupled between the VSW node and a reference potential node.
Aspect 4: The power supply circuit according to any of Aspects 1-3, wherein the detector circuit comprises: a first resistive element selectively coupled between a voltage rail and a switching voltage (VSW) node of the SMPS; and a comparator having an input coupled to the VSW node.
Aspect 5: The power supply circuit of Aspect 4, wherein the detector circuit further comprises a second resistive element selectively coupled between an output node of the SMPS and a reference potential node of the SMPS.
Aspect 6: The power supply circuit of Aspect 4 or 5, wherein the detector circuit further comprises a switch coupled in series with the first resistive element, wherein the switch is configured to be closed to detect the presence of the one or more circuit elements, and wherein the switch is configured to be open during voltage regulation via the SMPS.
Aspect 7: The power supply circuit according to any of Aspects 1-6, wherein the controller is further configured to cause one or more processing units to reduce power consumption based on the number of the one or more circuit elements that are present.
Aspect 8: The power supply circuit according to any of Aspects 1-7, wherein the controller is further configured to output a notification of the number of the one or more circuit elements that are present.
Aspect 9: The power supply circuit according to any of Aspects 1-8, wherein the SMPS comprises a buck converter.
Aspect 10: A method for voltage regulation, comprising: detecting a presence of one or more circuit elements of a switched-mode power supply (SMPS); configuring the SMPS to operate with a number of converter phases based on a number of the one or more circuit elements that are present; and generating, via the SMPS, a regulated voltage using the number of converter phases.
Aspect 11: The method of Aspect 10, wherein the one or more circuit elements of the SMPS comprise one or more of a plurality of inductive elements associated with multiple converter phases of the SMPS.
Aspect 12: The method of Aspect 11, wherein generating the regulated voltage comprises, for each of the multiple converter phases: charging a respective one of the plurality of inductive elements via a high-side (HS) switch coupled between a voltage rail and a switching voltage (VSW) node, the VSW node being coupled to the respective one of the plurality of inductive elements; and discharging the respective one of the plurality of inductive elements via a low-side (LS) switch coupled between the VSW node and a reference potential node.
Aspect 13: The method according to any of Aspects 10-12, wherein detecting the presence of the one or more circuit elements comprises: coupling a first resistive element between a voltage rail and a switching voltage (VSW) node of the SMPS; and comparing a voltage at the VSW node to a threshold to detect the presence of the one or more circuit elements.
Aspect 14: The method of Aspect 13, wherein detecting the presence of the one or more circuit elements further comprises coupling a second resistive element between an output node of the SMPS and a reference potential node of the SMPS.
Aspect 15: The method of Aspect 13 or 14, wherein: coupling the first resistive element between the voltage rail and the VSW node of the SMPS to detect the presence of the one or more circuit elements comprises closing a switch coupled in series with the first resistive element; and the method further comprises opening the switch to generate the regulated voltage.
Aspect 16: The method according to any of Aspects 10-15, further comprising causing one or more processing units to reduce power consumption based on the number of the one or more circuit elements that are present.
Aspect 17: The method according to any of Aspects 10-16, further comprising outputting a notification of the number of the one or more circuit elements that are present.
Aspect 18: An apparatus for voltage regulation, comprising: a memory; and one or more processors coupled to the memory, the one or more processors being configured to: receive an indication of a presence of one or more circuit elements of a switched-mode power supply (SMPS); and control the SMPS to operate with a number of converter phases based on a number of the one or more circuit elements that are present to generate a regulated voltage via the SMPS using the number of converter phases.
Aspect 19: The apparatus of Aspect 18, wherein the one or more processors are further configured to cause one or more processing units to reduce power consumption based on the number of the one or more circuit elements that are present.
Aspect 20: The apparatus of Aspect 18 or 19, wherein the one or more processors are further configured to output a notification of the number of the one or more circuit elements that are present.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation, and details of the methods and apparatus described above without departing from the scope of the claims.

What is claimed is:

1. A power supply circuit, comprising:
a switched-mode power supply (SMPS);
a detector circuit coupled to the SMPS and configured to detect a presence of one or more circuit elements of the SMPS; and
a controller coupled to the detector circuit and configured to control the SMPS to operate with a number of converter phases based on a number of the one or more circuit elements that are present.

2. The power supply circuit of claim 1, wherein the one or more circuit elements of the SMPS comprise one or more of a plurality of inductive elements associated with multiple converter phases of the SMPS.

3. The power supply circuit of claim 2, wherein the SMPS comprises, for each of the multiple converter phases:
a high-side (HS) switch coupled between a voltage rail and a switching voltage (VSW) node, the VSW node being coupled to a respective one of the plurality of inductive elements; and
a low-side (LS) switch coupled between the VSW node and a reference potential node.

4. The power supply circuit of claim 1, wherein the detector circuit comprises:
a first resistive element selectively coupled between a voltage rail and a switching voltage (VSW) node of the SMPS; and
a comparator having an input coupled to the VSW node.

5. The power supply circuit of claim 4, wherein the detector circuit further comprises a second resistive element selectively coupled between an output node of the SMPS and a reference potential node of the SMPS.

6. The power supply circuit of claim 4, wherein the detector circuit further comprises a switch coupled in series with the first resistive element, wherein the switch is configured to be closed to detect the presence of the one or more circuit elements, and wherein the switch is configured to be open during voltage regulation via the SMPS.

7. The power supply circuit of claim 1, wherein the controller is further configured to cause one or more processing units to reduce power consumption based on the number of the one or more circuit elements that are present.

8. The power supply circuit of claim 1, wherein the controller is further configured to output a notification of the number of the one or more circuit elements that are present.

9. The power supply circuit of claim 1, wherein the SMPS comprises a buck converter.

10. A method for voltage regulation, comprising:
detecting a presence of one or more circuit elements of a switched-mode power supply (SMPS);
configuring the SMPS to operate with a number of converter phases based on a number of the one or more circuit elements that are present; and
generating, via the SMPS, a regulated voltage using the number of converter phases.

11. The method of claim 10, wherein the one or more circuit elements of the SMPS comprise one or more of a plurality of inductive elements associated with multiple converter phases of the SMPS.

12. The method of claim 11, wherein generating the regulated voltage comprises, for each of the multiple converter phases:
charging a respective one of the plurality of inductive elements via a high-side (HS) switch coupled between a voltage rail and a switching voltage (VSW) node, the VSW node being coupled to the respective one of the plurality of inductive elements; and
discharging the respective one of the plurality of inductive elements via a low-side (LS) switch coupled between the VSW node and a reference potential node.

13. The method of claim 10, wherein detecting the presence of the one or more circuit elements comprises:
coupling a first resistive element between a voltage rail and a switching voltage (VSW) node of the SMPS; and
comparing a voltage at the VSW node to a threshold to detect the presence of the one or more circuit elements.

14. The method of claim 13, wherein detecting the presence of the one or more circuit elements further comprises coupling a second resistive element between an output node of the SMPS and a reference potential node of the SMPS.

15. The method of claim 13, wherein:
coupling the first resistive element between the voltage rail and the VSW node of the SMPS to detect the presence of the one or more circuit elements comprises closing a switch coupled in series with the first resistive element; and
the method further comprises opening the switch to generate the regulated voltage.

16. The method of claim 10, further comprising causing one or more processing units to reduce power consumption based on the number of the one or more circuit elements that are present.

17. The method of claim 10, further comprising outputting a notification of the number of the one or more circuit elements that are present.

18. An apparatus for voltage regulation, comprising:
a memory; and
one or more processors coupled to the memory, the one or more processors being configured to:
receive an indication of a presence of one or more circuit elements of a switched-mode power supply (SMPS); and
control the SMPS to operate with a number of converter phases based on a number of the one or more circuit elements that are present to generate a regulated voltage via the SMPS using the number of converter phases.

19. The apparatus of claim 18, wherein the one or more processors are further configured to cause one or more processing units to reduce power consumption based on the number of the one or more circuit elements that are present.

20. The apparatus of claim 18, wherein the one or more processors are further configured to output a notification of the number of the one or more circuit elements that are present.
